(19) United States
(12) Patent Application Publication
(10) Pub. No.: US 2015/0026005 A1
(43) Pub. Date: Jan. 22, 2015

(54) MULTI ECOMMERCE FLOATING WINDOW WITH A SHOPPING CART

(71) Applicant: BUY AMERICA US CORP., Wilmington, DE (US)

(72) Inventors: OZ SHAMIA, Tel-Aviv (IL); KEREN COHEN, Kfar Yona (IL); LIRON D LIPTZ, Even Yehuda (IL); OFER YOSEF STEGMAN, Rannana (IL)

(73) Assignee: BUY AMERICA US CORP., Wilmington, DE (US)

(21) Appl. No.: 13/944,900

(22) Filed: Jul. 18, 2013

(51) Int. Cl. G06Q 30/06

(52) U.S. Cl. CPC G06Q 30/0633
USPC 705/26.8

(57) ABSTRACT

The present invention is directed to a novel multi ecommerce floating window configured to allow a shopper to surf and collect variety of items/products from separated independent ecommerce websites into one electronic shopping cart. The invention is also directed to a method and system for purchasing products from a plurality of unrelated internet commerce sites offering products for purchase through electronic commerce systems using said novel multi ecommerce floating window provided herein. The shopper may purchase the collected products in the shopping cart by a single payment process that is independent of the ecommerce sites that the products were collected from. Finally, the purchased products are all being gathered into one package to be delivered to the shopper. The multi ecommerce floating window comprising at least a predefined group of ecommerce sites that the shopper may choose for surfing, and a shopping cart configured to allow addition of items/products selected from either one of the ecommerce sites, wherein the floating window accompanies the shopper to each ecommerce site that the shopper chooses to surf.

### TECHNOLOGICAL FIELD

The invention is related to the field of electronic commerce in general and to a smart multi sites floating window with a shopping cart, in particular.

### BACKGROUND

Purchasing products through electronic methods (i.e. electronic commerce) is becoming increasingly more common as consumers realize the convenience of shopping at multiple electronic stores 24 hours a day from a single physical location. In recent years ecommerce overseas became a high fashion model thanks to the enormous variety of merchandize that is easily available to consumers, providing them an international shopping experience with the excitement and essence of shopping abroad, without having to travel overseas.

Ecommerce from abroad is in a way troublesome as many web sites do not deliver to the consumer country, the payment is in foreign current, and besides the merchant cost, additional costs such as delivery cost, custom VAT, insurance of the merchandize and else, may increase the purchased item cost tremendously. In addition, when the consumer is interested to purchase several items that are being offered for sale in more than one web site, the consumer should purchase from each site separately, thus, having to deal with number of shipments and pay the basic shipping fees for each shipment. This situation is undoubtedly non efficient and tremendously wasteful to the shopper, that is enforced to deal with multiple deliveries of purchased products.

### GENERAL DESCRIPTION

There is a need in the art for a friendly and convenient shopping system and method allowing a consumer an opportunity to purchase items from different separated ecommerce sites and to have all items in one shopping cart with minimal and optimal shipment costs. The present invention provides such a multi ecommerce shopping system based on a novel multi ecommerce floating window that is configured to accompany the shopper along its internet shopping spree. The terms “item” and “product” are used herein interchangeably and refer to any merchant offered for sale via the internet in an electronic commerce site.

In accordance with one main aspect of the present invention a system for purchasing products from a plurality of unrelated internet sites offering products for purchase through electronic commerce systems is provided. The system comprising: (a) a smart device with an access to the internet; (b) an internet site comprising an independent floating window configured to accompany a shopper along its internet shopping spree so as to allow the shopper to surf and collect variety of products from said unrelated electronic commerce websites into one electronic shopping cart, and to purchase the collected products by a single payment process that is independent of the unrelated electronic commerce sites that said products were collected from; and (c) a provision array configured to physically collect the purchased products and to deliver them in one package to the shopper.

The novel multi ecommerce floating window (hereinafter: “MEFW” or “floating window”, interchangeably) is configured to allow a shopper to surf and collect variety of items from separated independent ecommerce websites into one electronic shopping cart. The shopper may purchase the collected items in the cart by a single payment process that is independent of the ecommerce sites that the items were collected from, and then the purchased items are all being gathered into one package to be delivered to the shopper.

The floating window with the multi ecommerce shopping cart configured to provide a shopper an opportunity to surf and purchase variety of items selected from separate independent websites, and to gather the selected items into one shopping cart via the floating window provided herein. The MEFW is further configured to allow the shopper to pay one single payment for the entire shopping cart although it contains items that were gathered from different web sites and finally, the purchased items are physically implemented into one package delivered to the shopper, preferably by a courier. The system provided herein with the novel MEFW is further configured to optimize the shipping costs for each purchase by providing the shopper different notices related to additional purchase offers of items so as to obtain a more profitable total price.

The novel MEFW provides the shopper an opportunity to surf and purchase variety of items that may be selected from separated websites, and to gather the selected items into one shopping cart. This is achieved via the novel floating window that is configured to allow the shopper to allegedly surf in a variety of ecommerce sites that the shopper chooses from a predefined list of sites within the floating window, while during the surfing time the floating window escorts the shopper all the way in his/her shopping spree as an upper layer that moves with the shopper to each ecommerce site that the shopper chooses to surf in.

### BRIEF DESCRIPTION OF THE DRAWINGS

Example illustrative of embodiments of the disclosure are described below with reference to the figures attached hereto. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings.

The figures (Figs.) are listed below.

FIG. 1 is a schematic illustration of an example of a multi ecommerce floating window with a shopping cart according to some embodiment of the invention;

FIG. 2 is a flow diagram of an example of a purchase process in different ecommerce sites conducted by using the floating window with the shopping cart of FIG. 1 according to one possible embodiment of the invention;

FIGS. 3 is a schematic diagram illustration of a process of suggesting a better price to the shopper of an item that was added to the shopping cart of FIG. 1.

### DETAILED DESCRIPTION OF EMBODIMENTS

In the following description, various aspects of a novel multi ecommerce floating window with a shopping cart configured to allow gathering of several items collected from different ecommerce sites into one shopping cart will be described. For the purpose of explanation, specific configurations and details are set forth in order to provide a thorough understanding of the invention.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

In accordance with one main aspect of the present invention, a MEFW configured to allow a shopper to surf and collect variety of items from separated independent ecommerce websites into one electronic shopping cart is provided. The shopper may purchase the collected items/products in the cart by a single payment process that is independent of the ecommerce sites that said items were collected from, and then the purchased items are all being gathered into one package to be delivered to the shopper.

The MEFW provided herein comprises at least a predefined group of ecommerce sites that the shopper may choose for surfing, and a shopping cart configured to allow addition of items selected from either one of the ecommerce sites, wherein the floating window is configured to accompany the shopper to each ecommerce site that the shopper chooses to surf.

Each site represented in the predefined group of ecommerce sites is actually, a duplicate of a primary ecommerce web site that was created at a specific time point, and it is configured to be updated at short time intervals, in order to reflect to the shopper an updated duplicate of each primary ecommerce web site. Creation of such a duplicate website to each ecommerce site, allows the shopper to perform the search of items in a faster and more efficient manner and simultaneously, the creation of extensive load on the primary ecommerce site is avoided.

In some embodiments of the invention, upon addition of an item to the shopping cart the dimensions of the floating window increases and a description of the selected item, its price in local current of the shopper, and the delivery costs are displayed.

In some embodiments, the floating window is further configured to optimize shipping costs for each purchase by providing the shopper various notices related to additional purchase offers of products, so as to obtain a more profitable total price.

The present invention is also directed to a system for purchasing products from a plurality of unrelated internet commerce sites offering products for purchase through electronic commerce systems, the system comprising: a smart device with an access to the internet; an internet site comprising a multi ecommerce floating window as described above; and a provision array configured to physically collect the purchased products and to deliver them in one package to the shopper.

The provision array is configured and operable to execute the electronic transaction, by realization of the electric shopping cart into a real shopping cart, i.e., by physical collection of the purchased items, each from the ecommerce site it was offered for sale, into one deliverable package, and to ship the package with all the purchased items to the shopper, according to tax and custom requirements.

The present invention is further directed to a system for purchasing products from a plurality of unrelated internet sites offering products for purchase through electronic commerce systems, the system comprising: (a) a smart device with an access to the internet; (b) an internet site comprising an independent floating window configured to accompany a shopper along its internet shopping spree so as to allow the shopper to surf and collect variety of products from said unrelated electronic commerce websites into one electronic shopping cart, and to purchase the collected products by a single payment process that is independent of the unrelated electronic commerce sites that said products were collected from; and (c) a provision array configured to physically collect the purchased products and to deliver them in one package to the shopper.

The invention is also directed to a system for purchasing products from a plurality of unrelated internet commerce sites, the system comprising a multi ecommerce floating window configured to allow a shopper to surf and collect variety of products from separated independent commerce websites into one electronic shopping cart, wherein the products are being purchase by a single payment process that is independent of the commerce websites that the products were collected from, and wherein the purchased products are all being gathered into one package to be delivered to the shopper.

The floating window comprises at least a predefined group of ecommerce sites that the shopper may choose for surfing, and a shopping cart configured to allow addition of products selected from either one of said ecommerce sites, wherein the floating window is configured to accompany the shopper to each ecommerce site that the shopper chooses to surf. For example, the shopper may chose to surf in ecommerce site A, to switch to ecommerce site B and then to surf again in ecommerce site A and so on with all ecommerce sites contained in the predefined group of sites that may appear for example as icons in the MEFW. During the entire surfing time the floating window “trail” after the shopper and appears as an upper layer positioned on top of the ecommerce site being surfed at a specific time.

Each ecommerce site included in the predefined group of ecommerce sites is actually a duplicate of a primary ecommerce web site created at a specific time point, that is further configured to be updated at short time intervals so as to reflect to the shopper an updated duplicate of each primary ecommerce web site.

In some embodiments, upon addition of a product to the shopping cart the dimensions of the floating window increases and a description of the added product, its price in local current of the shopper, and the delivery costs are displayed.

Additionally, the system may further be configured to optimize shipment costs for each purchase by providing the shopper various notices related to additional purchase offers of products so as to obtain a more profitable total price.

Reference is now made to the figures.

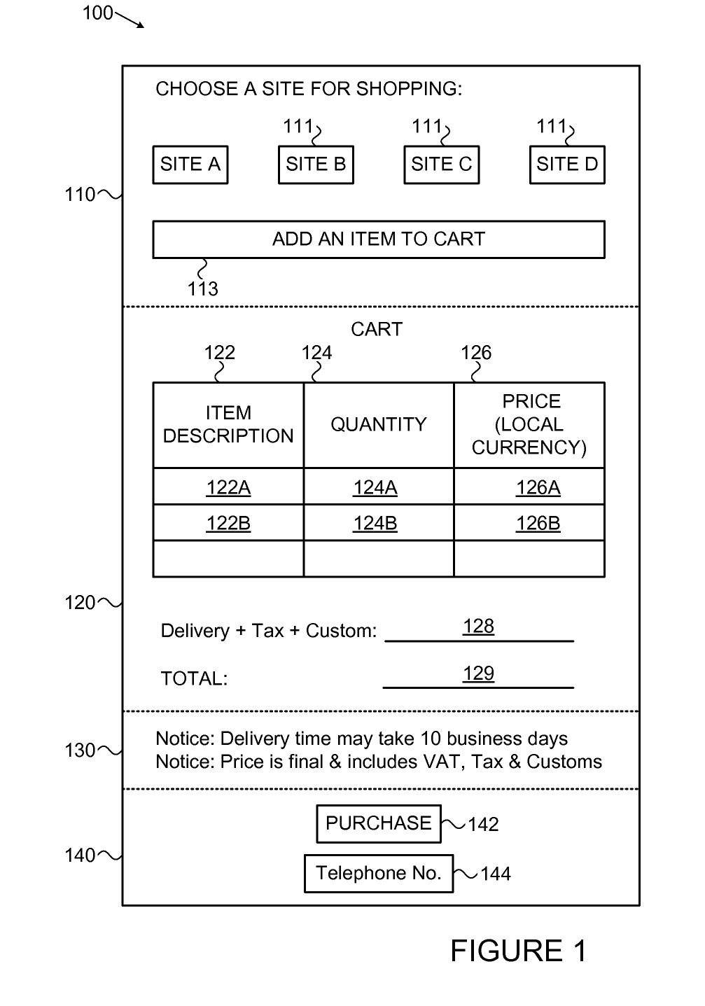

FIG. 1 schematically shows one optional example of a MEFW (multi ecommerce floating window) 100 with a shopping cart according to some embodiment of the invention. When a shopper (i.e. customer) enters a web site configured and operable to display floating window 100, the floating window 100 is displayed in a minimal form such that only the upper section 110 of the MEFW 100 is visible to the shopper until a first item is added to a shopping cart comprised in MEFW 100.

Upper section 110 comprises a variety of ecommerce sites icons 111 that the shopper may choose for shopping, and button 113 “ADD TO CART” configured to allow the shopper the ability to select an item from any one of the ecommerce sites 111 and add it to shopper's personal shopping cart that in the end of the shopping process will be gathered into one package and delivered to the shopper in his/her country.

Upon clicking on one of the icons of the ecommerce sites 111 a new window configured to represent the content of the selected ecommerce site in a specific time point is opened, and the floating window floats to the new window and being represented on it as an upper layer. The shopper may now surf in the selected ecommerce matching site and start shopping. When the shopper finds an item A that he/she is interested to buy, the shopper clicks on button 113. This action expose to the shopper another section 120 of floating window 100 mainly representing the shopping cart content. Section 120 generally comprises a description of the chosen item 122, wherein 122A is a description of item A, 122B is a description of item B, etc.; the number of units that the shopper is interested to buy is denoted in section 124, wherein the number of items of item A are 124A, the number of unit of item B are 124B, and so on, including the ability to increase or decrease the number of units of each item selected; the price of the selected items (multiplied according to the number of units selected) is denoted in section 126, preferably in the local current of the shopper, wherein the price of item A is 126A, the price of item B is 126B, and so on. Section 120 of floating window 100 further contains a rubric configured to display to the shopper additional charge 128 that is added to the selected item and includes the delivery cost, V.A.T. that should be paid, and custom that is charged for the selected item according to the rules of the shopper's country.

When the shopper adds to the cart a second item (item B), the new item description 122B is added, as well as the number of units of item B that the shopper is interested to buy 124B, including the ability to add or decrease the number of units of the same item, and the price of item B 126 in local current.

Section 120 further comprises a rubric 129 configured to display to the shopper the total charge for the items added to the shopping cart and the total delivery cost to the shopper.

After the shopper adds an item to the shopping cart, rubrics 128 and 129 are updated accordingly.

According to some embodiments, floating window 100 may further comprise notices section 130 that provides various notices to the shopper such as without limitation: “Delivery time may take 10 to 12 business days”; “Price is final and includes VAT and custom tax”, etc. This section may further comprise beneficiary purchase offers and tips to the shopper as to similar items in better price offer, etc.

Last section 140 of floating window 100 contains a button 142 that upon clicking on it the shopper performs the purchase act, pay for the goods and the content of the shopping cart is further delivered to an operation net that is responsible to gather the purchased items into one package and send it to the shopper within the time frame and term as set in the floating window and/or the web site comprising the MEFW 100.

In some embodiment of the invention section 140 may further contain contact details such as a telephone number 144, an email address (not shown), or a social net communication channel such as Facebook, twitter, or else (not shown). Alternatively, contact details may be included in any other section of the multi ecommerce floating window 100 described herein.

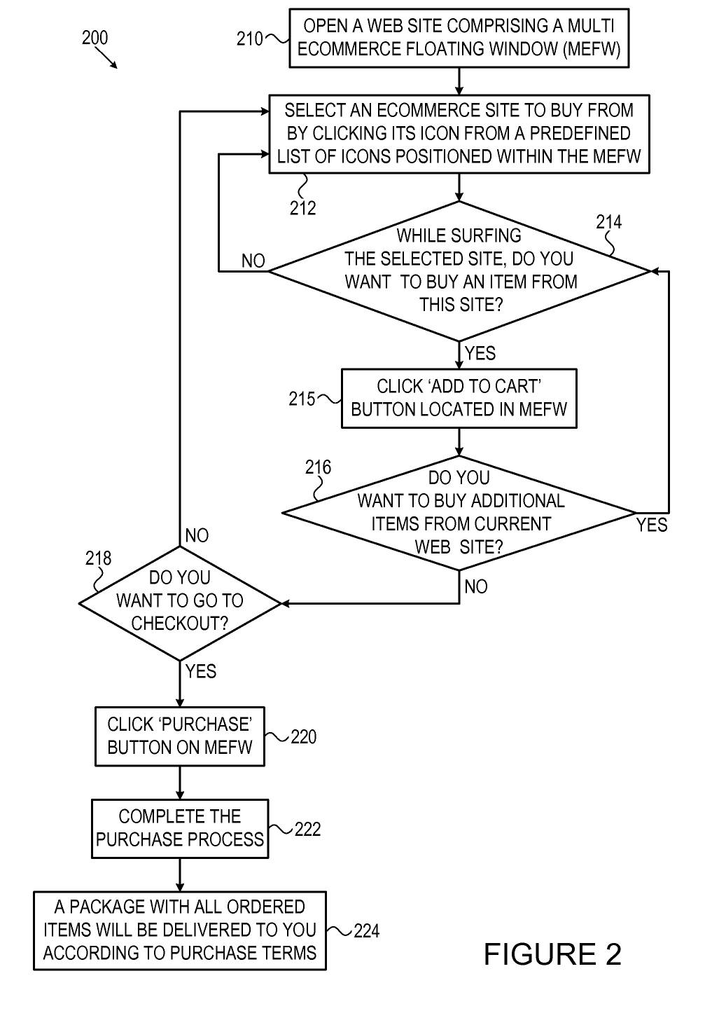

FIG. 2 is a flow diagram 200 of an example of a purchase process in different ecommerce sites using MEFW 100 of FIG. 1 according to one possible embodiment of the invention.

At a first step 210 the shopper (i.e. customer) enters a web site configured and operable to display floating window 100. In the next step 212 the shopper chooses within MEFW 100 a specific ecommerce site to surf in for shopping from the list of sites shown within floating window 100, by clicking on the chosen site icon 111 as illustrated in FIG. 1. By this action, a new window is opened viewing to the shopper the content of the chosen site as was downloaded in a timeframe adjacent to the entry of the shopper so as to allow the shopper to surf and search items in a fast and efficient manner without creating an undesired load on the original ecommerce web site, wherein the floating window 100 appears as an independent layer on top of the downloaded ecommerce site providing the shopper an option to add an item to a shopping cart and/or to switch to another ecommerce site.

The next step 214 is a junction in which, while the shopper surfs the selected site (and more precisely the matching site) he/she should decided if he/she want to buy an item viewed in the site. If the shopper finds an item that he/she is interested to buy, then the next step 215 is to click on “Add to cart” option in MEFW 100 and add it to the shopping cart. If the shopper is not interested in buying any item from the selected ecommerce site, then the shopper goes back to step 212 to open another ecommerce (downloaded) site from the list. In the scenario that the shopper adds an item to the cart, the dimensions of MEFW 100 increase so as to provide the shopper a real time view of the item selected to be added to the cart, the item's price in local current, and the additional sum that the shopper should pay for delivery and taxes. Next step 216 is a junction in which the shopper should choose whether to continue surfing at the same ecommerce site and optionally buy additional item/s from this site or not. If the shopper wish to continue surfing at the same web site (the answer is YES) the shopper goes back to step 214. If the shopper is not interested to continue surfing at the same web site (the answer is NO) he/she arrives to additional junction 218 in which the shopper should decide whether to go to checkout (i.e. to the cash) or not. If the shopper chooses to go to checkout (the answer is YES), than on the next step 220 the shopper should click on the ‘Purchase’ button located in the MEFW 100 (denoted as 142 in FIG. 1) and afterwards, in step 222 complete the purchase process. In order to complete the purchase process the shopper is required to enter his/her details including personal details such as name, address, telephone number, as well as details of payment means such as credit card details. It should be noted that in accordance with the present invention the purchase process and payment are independent processes that relates directly to the web site comprising the MEFW 100 and not to the original ecommerce sites that provides the items to be added to the shopping cart. By using the novel MEFW 100 of the present invention the shopper is capable of collecting items from different ecommerce sites into one package that contains all items selected that will be delivered to the shopper, altogether at the same time according to the purchase terms. The shopper will pay one delivery and the total saving for the shopper may be substantial. In addition, since the payment is conducted to one independent entity, the shopper may dived the payments by installments.

If the shopper chooses on step 218 not to go to checkout (the answer is NO) then, the shopper returns to step 212 in which an ecommerce site for surfing is selected from the list of site available in the MEFW 100 by clicking on its icon (111 in FIG. 1).

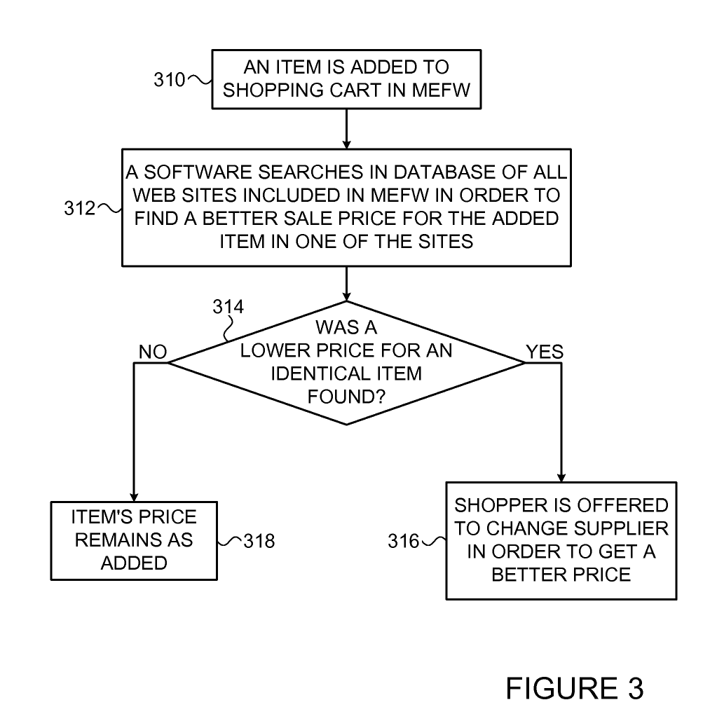

FIGS. 3 is a schematic flow chart diagram 300 illustrating a process of finding a cheaper price offer to an item that was added to the cart.

In some embodiments of the invention, the MEFW 100 is a “smart” window that may suggest a better price offer for items added to the cart. Such embodiment is illustrated in flow chart 300 showing one example of sequential actions performed by a proprietary software operated by the web site comprising the MEFW 100, so as to suggest to the shopper a better price offer for an item that was added to the cart.

In the first step 310, an item is added by the shopper to the shopping cart in MEFW 100. This action leads to step 312, in which a search is conducted in the database of all websites included in MEFW 100 in order to find a better sale price for the added item in one of the sites included in the database. The next step 314 is a junction depending on the question whether a lower price for an identical item was found? It the answer is Yes, then the next step 316 is to offer the shopper to change supplier in order to get a better price. If the answer is No, then in the next step 318 the item's price remains as was initially added.

In some embodiments of the invention, the virtual MEFW 100 may provide the shopper additional notices that may optimize/maximize/benefit the purchase process for the shopper. For example, a notice informing the shopper that addition of units from a certain item that was added to the cart will decrease the price per unit considering the total delivery fees (based on weight, of all costs including delivery fees and taxes in the specific country to which the package will be delivered to).

Another example of such notice is a notice offering to the shopper to purchase certain items based on the content of the cart, whereby the addition of one or more of the proposed item will reduced drastically the total cost required if the item was purchased separately.

The present invention is also directed to a method for purchasing products from a plurality of unrelated internet commerce sites offering products for purchase through electronic commerce systems, said method comprising: a. entering the internet via a smart device with an access to the internet; b. entering an internet site comprising an independent floating window configured to accompany a shopper along its internet shopping spree; c. selecting at least two ecommerce sites from a predefined group of unrelated ecommerce sites comprised in the floating window; d. surfing in the selected ecommerce sites and adding variety of products from said websites into one electronic shopping cart comprised in said floating window; and e. purchasing the collected products by a single payment process that is independent of the unrelated electronic commerce sites that said products were collected from.

The purchased products are all being gathered into one package and being delivered to the shopper.

The floating window of the provided method comprises at least a predefined group of ecommerce sites that the shopper may choose for surfing, and a shopping cart configured to allow addition of products selected from either one of said ecommerce sites. The floating window is configured to accompany the shopper to each ecommerce site that the shopper chooses to surf.

In accordance with the method provided herein, each commerce site included in said predefined group of ecommerce sites is a duplicate of a primary ecommerce web site created at a specific time point, that is further configured to be updated at short time intervals so as to reflect to the shopper an updated duplicate of each primary ecommerce web site.

Also, upon addition of a product to the shopping cart the dimensions of the floating window increases and a description of the added product, its price in local current of the shopper, and the delivery costs are displayed.

In some embodiments, the method provided herein for purchasing products from a plurality of unrelated internet commerce sites is further configured to optimize shipping costs for each purchase by the following step: f. providing the shopper at least one notice related to additional purchase offers of products so as to obtain a more profitable total price to the shopper's package.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A multi ecommerce floating window configured to allow a shopper to surf and collect variety of items from separated independent ecommerce websites into one electronic shopping cart, wherein said shopper may purchase the collected items in the shopping cart by a single payment process that is independent of the ecommerce sites that said items were collected from, and wherein the purchased items are all being gathered into one package to be delivered to the shopper.

2. A multi ecommerce floating window according to claim 1, wherein said floating window comprises at least a predefined group of ecommerce sites that the shopper may choose for surfing, and a shopping cart configured to allow addition of items selected from either one of said ecommerce sites, and wherein the floating window is configured to accompany the shopper to each ecommerce site that the shopper chooses to surf.

3. A multi ecommerce floating window according to claim 2, wherein each site included in said predefined group of ecommerce sites is a duplicate of a primary ecommerce web site created at a specific time point, that is further configured to be updated at short time intervals so as to reflect to the shopper an updated duplicate of each primary ecommerce web site.

4. A multi ecommerce floating window according to claim 1, wherein upon addition of an item to the shopping cart the dimensions of the floating window increases and a description of the selected item, its price in local current of the shopper, and delivery costs are displayed.

5. A multi ecommerce floating window according to claim 1, further configured to optimize shipping costs for each purchase by providing the shopper various notices related to additional purchase offers of items so as to obtain a more profitable total price.

6. A system for purchasing products from a plurality of unrelated internet sites offering products for purchase through electronic commerce systems, said system comprising: a smart device with an access to the internet; a multi ecommerce floating window according to claim 1; and a provision array configured to physically collect the purchased products and to deliver said products in one package to the shopper.

7. (canceled)

8. A system for purchasing products from a plurality of unrelated internet commerce sites, said system comprising a multi ecommerce floating window configured to allow a shopper to surf and collect variety of products from separated independent ecommerce websites into one electronic shopping cart, wherein said products are being purchased by a single payment process that is independent of the ecommerce websites that said products were collected from, and wherein the purchased products are all being gathered into one package to be delivered to the shopper.

9. A system for purchasing products from a plurality of unrelated internet commerce sites according to claim 8, wherein said floating window comprising at least a predefined group of ecommerce sites that the shopper may choose for surfing, and a shopping cart configured to allow addition of products selected from either one of said ecommerce sites, and wherein the floating window is configured to accompany the shopper to each commerce site that the shopper chooses to surf.

10. A system for purchasing products from a plurality of unrelated internet commerce sites according to claim 9, wherein each commerce site included in said predefined group of ecommerce sites is a duplicate of a primary ecommerce web site created at a specific time point, that is further configured to be updated at short time intervals so as to reflect to the shopper an updated duplicate of each primary ecommerce web site.

11. A system for purchasing products from a plurality of unrelated internet commerce sites according to claim 8, wherein upon addition of a product to the shopping cart the dimensions of the floating window increases and a description of the added product, its price in local current of the shopper, and the delivery costs are displayed.

12. A method for purchasing products from a plurality of unrelated internet commerce sites offering products for purchase through electronic commerce systems, said method comprising:
a. entering the internet via a smart device with an access to the internet;
b. entering an internet site comprising an independent floating window configured to accompany a shopper along its internet shopping spree;
c. selecting at least two ecommerce sites from a predefined group of unrelated ecommerce sites comprised in the floating window;
d. surfing in the selected ecommerce sites and adding variety of products from said websites into one electronic shopping cart comprised in said floating window;
e. purchasing the collected products by a single payment process that is independent of the unrelated electronic commerce sites that said products were collected from.

13. A method for purchasing products from a plurality of unrelated internet commerce sites according to claim 12, wherein the purchased products are all being gathered into one package and being delivered to the shopper.

14. A method for purchasing products from a plurality of unrelated internet commerce sites according to claim 12, wherein said floating window comprising at least a predefined group of ecommerce sites that the shopper may choose for surfing, and a shopping cart configured to allow addition of products selected from either one of said ecommerce sites, and wherein the floating window is configured to accompany the shopper to each ecommerce site that the shopper chooses to surf.

15. A method for purchasing products from a plurality of unrelated internet commerce sites according to claim 12, wherein each commerce site included in said predefined group of ecommerce sites is a duplicate of a primary ecommerce web site created at a specific time point, that is further configured to be updated at short time intervals so as to reflect to the shopper an updated duplicate of each primary ecommerce web site.

16. A method for purchasing products from a plurality of unrelated internet commerce sites according to claim 12, wherein upon addition of a product to the shopping cart the dimensions of the floating window increases and a description of the added product, its price in local current of the shopper, and the delivery costs are displayed.

17. A method for purchasing products from a plurality of unrelated internet commerce sites according to claim 12, further configured to optimize shipping costs for each purchase by the following step:
f. providing the shopper at least one notice related to additional purchase offers of products so as to obtain a more profitable total price to the shopper's package.
